(19) United States
(12) Patent Application Publication
(10) Pub. No.: US 2004/0253361 A1
(43) Pub. Date: Dec. 16, 2004

(54) Clear liquid creamer composition

(76) Inventors: Mark Allen Einerson, Hilliard, OH (US); Teresita Bautista Pascual, Marysville, OH (US)

Correspondence Address: WINSTON & STRAWN, PATENT DEPARTMENT, 1400 L STREET, N.W., WASHINGTON, DC, 20005-3502, US

(21) Appl. No.: 10/887,749

(22) Filed: Jul. 9, 2004

Related U.S. Application Data
(63) Continuation of application No. PCT/EP02/14855, filed on Dec. 18, 2002.

(51) Int. Cl. A23D 7/00

(52) U.S. Cl. 426/601

(57) ABSTRACT

A beverage creamer composition is provided that is transparent, but when added to a liquid to be creamed, turns opaque and creamy in appearance. The creamer is preferably provided as a liquid emulsion having a lipid phase dispersed in an aqueous phase. The phases have refractive indices that are equal or substantially equal. One of the phases may include a solute such as a non-reducing sugar in the aqueous phase to adjust its refractive index to a equal the refractive index of the lipid phase. The creamer is preferably provided in transparent packaging.

### CROSS-REFERENCE TO RELATED APPLICATIONS

This application is a continuation of International application PCT/EP02/14855 filed Dec. 18, 2002, and claims the benefit of provisional application no. 60/350,247 filed Jan. 17, 2002. The entire content of each application is expressly incorporated herein by reference thereto.

### FIELD OF INVENTION

The invention relates to a creamer composition and use thereof in whitening a beverage such as a coffee or tea beverage. The invention relates also to methods of making the said creamer.

### BACKGROUND OF THE INVENTION

Compositions for creamers are well known in the art. Most creamers are provided in dry powder form for addition to beverages that, in the perception, or according to the preference of the consumer, require whitening, lightening or creaming. Creamer formulations are also available in liquid form. These are often encountered in single serve packaging, such as capsules or sachets as well as multiserve packaging. The liquid emerges with a milky appearance. However, there is now perceived to be a need in the market place for a product that functions as a creamer, but does not initially appear to be one.

This invention describes a creamer that does not have the appearance of a dairy product, yet functions to whiten a beverage when added to it.

### SUMMARY OF THE INVENTION

According to a first aspect of the invention, there is provided a creamer composition that is transparent. Preferably, the creamer composition is colorless, but it can also be colored but transparent.

In a preferred form of the invention, the creamer composition comprises at least two phases. In an embodiment, at least one phase is an aqueous phase while at least one other phase comprises a lipid phase. In an embodiment, the composition comprises an aqueous phase that is continuous and a lipid phase that is dispersed in the aqueous phase. Preferably, the creamer composition is in the form of an emulsion.

A desirable form of the creamer composition of the invention is as a liquid. In a preferred embodiment, each phase of the composition has a refractive index that is equal or at least substantially equal to that of each other phase so that a transparent or clear composition is provided.

In a further preferred form of the invention, at least one of the phases comprises a solute in sufficient quantity for adjusting the refractive index of that phase to a value that equals or approximately equals the refractive index of the or each other phase, to provide a clear composition. The refractive index of each phase in the composition is preferably in the range from about 1.43 to about 1.48.

In an embodiment, the composition comprises an aqueous phase and a lipid phase and the solute is included in the aqueous phase. Preferably, the aqueous phase comprises from about 40% to about 85% by weight solute. A preferred solute is an edible carbohydrate, such as a low molecular weight carbohydrate. Preferably, the carbohydrate is a non-reducing sugar, and one that is non-browning. Sucrose is a suitable non-reducing sugar. The aqueous phase of the creamer preferably comprises from about 40% to about 85% by weight of sugar, more preferably from 50% to 80% and most preferably from about 55% to 70% by weight of sugar.

In another embodiment, the creamer composition has a water activity of about 0.9 or less, preferably about 0.85 or less.

The lipid phase preferably comprises an edible oil. The oil is preferably hydrogenated and should have a melting point of about 35° C. or less. In a preferred embodiment, the lipid phase comprises about 25% or less of the total weight of the creamer composition, and more preferably from about 5% to about 20% thereof.

According to a further aspect of the invention, a method of manufacturing a creamer composition comprises providing a first component selected to have creamy mouthfeel characteristics, when diluted in a beverage, to form a first phase and a second component to form a second phase when mixed with the first, and mixing the first and second components together to provide a clear composition.

In a preferred form of the invention, the step of mixing includes forming an emulsion of the phases. To obtain a clear composition, the method includes adjusting the refractive index of at least one phase, if necessary, to equal or substantially equal the value of the or each other phase.

At least one of the components is a liquid, with in one embodiment, the first phase comprising an edible lipid constituent to provide a lipid phase. The second phase may be an aqueous solvent to provide an aqueous phase. In an embodiment, the method includes the step of dissolving in sufficient quantity in one of the phases a solute for adjusting the refractive index of the that phase to a value that equals or approximately equals the refractive index of the other phase, to provide a clear composition. In a further preferred form of the method of the invention, the solute is dissolved in the aqueous phase. In an embodiment, the emulsion of the composition comprises an oil phase dispersed in an aqueous phase.

According to third aspect of the invention, a method of creaming a beverage comprises providing an beverage to be rendered creamy, providing a transparent beverage creamer composition and mixing sufficient of the said composition with the beverage until the beverage takes on a desired creamy appearance.

In a preferred form of the invention, the creamer composition is in liquid form.

In a further preferred form of the invention, the creamer composition is provided in concentrate form.

In an embodiment of the invention, the beverage is aqueous.

In a further form of the invention, there is provided creamer composition comprising at least two phases having equal or substantially equal refractive indices so as to render the composition substantially transparent.

An advantage of the invention is that a surprising effect is obtainable when the clear creamer composition turns the beverage, to which it is added, creamy.

A further advantage is that the creamy effect is obtainable without necessarily using diary-derived constituents.

### DETAILED DESCRIPTION OF THE PREFERRED EMBODIMENTS

The invention relates to a creamer for a beverage, where the creamer does not have the appearance of a dairy product but is provided as a clear transparent composition. The composition may be a liquid or in the form of a flowable semi-solid, such as a gel or paste. When diluted by being added to a beverage to be creamed, it provides the beverage with creamy organoleptic properties. It is preferably provided as a concentrate. In a preferred form, it has the capacity to turn opaque and creamy on being diluted by being added to a beverage that is to be whitened or creamed.

In embodiments, the creamer composition comprises at least two phases having equal or at least closely matching refractive indices for each phase. Preferably, the refractive indices are equal prior to dilution in the beverage to be creamed. Should the refractive index of any of the phases be changed, the composition becomes creamy in appearance. In use, the phase change takes place when the creamer composition is diluted in the beverages to be creamed. In preferred embodiments, one of the phases is dispersed in the other or others, preferably to provide an emulsion.

The liquid composition in preferred embodiments thus comprises a continuous, aqueous phase and a dispersed, lipid phase. The phases have respective refractive indices that are at least substantially equal and preferably are equal. The composition may include a component selected to dissolve in one of the phases so that, once dissolved, it adjusts the refractive index of the phase in which it has dissolved so that it at least closely approximates the refractive index (RI) of the other phase. Preferably, after adjustment, the refractive indices of the phases are equal.

In an embodiment, the creamer composition comprises an emulsion of the dispersed phase within the continuous phase as dispersion medium. The refractive index of the dispersed phase is selected or adapted to be substantially equal to that of the continuous dispersion medium.

In a preferred embodiment, the refractive index of the aqueous phase is adjusted to correspond to the refractive index of the lipid phase.

The refractive index of the lipid phase typically varies from 1.43 to 1.48, depending on the choice of lipid constituent. Preferred lipid phase components include lauric fat, such as is present in palm-kernel oil and coconut oil, having an RI of about 1.45 and non-lauric fat, for example canola oil, having an RI of about 1.47.

With regard to the aqueous phase, as the refractive index of water is about 1.33 at normal room temperatures, to provide a clear emulsion when an oil is added, its RI needs to be adjusted. To adjust it, in this case by raising it to the level of the fat, a water-soluble, RI-raising component is dissolved in it. Certain low molecular weight carbohydrates have been found to achieve this. Preferred such carbohydrates are non-reducing, non-browning sugars. A suitable choice of a sugar meeting these requirements is sucrose. Should a certain degree of browning be desired in the liquid creamer, however, a browning sugar like corn syrup may be used. This alternative gives the transparent liquid creamer a brownish hue. It will be appreciated that other colorants may be added to the creamer to provide a desired color. These may be selected from those well known in the beverage art. It is therefore not beyond the scope of this invention to provide transparent creamer liquids having blue, green, orange, red, mauve or brown or other tinges or hues, as may be desired.

In liquid form embodiments of the creamer composition, the lipid phase preferably comprises from about 0% to 25% by weight of the total creamer composition. Preferably, it comprises from about 10% to 20% by weight of the creamer, more preferably from about 12%-18% by weight, and most preferably from about 13%-15% by weight of the total composition. Advantageously, the oil component in the lipid phase should have good oxidation stability and a low melting point. Preferably the oil has a melting point of about 35° C. or less.

The oil is preferably lightly hydrogenated, i.e., that the amount of hydrogenation does not increase the melting point or decrease the refractive index of the oil. As excessive hydrogenation leads to an increase in melting point and a decrease of refractive index, correspondingly greater degree of adjustment of the RI of the aqueous phase would be required.

In preferred embodiments, therefore, the aqueous phase comprises the balance of the composition. Of the total composition, water comprises preferably from about 20% to 33% by weight and further preferably from about 25% to 30% by weight.

In embodiments where the creamer composition is presented in semi-solid form, the composition comprises sufficient hydrocolloid gum to raise the viscosity so that flowability decreases. The lipid phase proportion may also be suitably raised. In such embodiments, the composition may be provided as a gel-like squeezable mass or spoonable paste. The hydrocolloid may be gelling or non-gelling. Where the hydrocolloid selected is non-gelling, for example xanthan gum, a paste-like product results. Where it is gelling, for example alginate, the composition assume a gel form.

In the case where the RI-adjusting component is a sugar, it preferably comprises from about 50% to about 60% by weight of the total composition and, more preferably, from about 53% to 58% by weight.

In the aqueous phase, however, the carbohydrate, such as a non-browning sugar, may comprise from about 40% to about 85% by weight thereof. In preferred embodiments, the aqueous phase comprises from about 50% to 80% and, more preferably, from about 55% to 70% sucrose by weight.

Water activity A_{w} of the liquid creamer composition is 0.9 or less and desirably no more than about 0.85. This has the advantage of obviating the need for a high degree of sterilization of the actual composition. It is desirable that the composition be filled into aseptic packaging in cases where the water activity value approaches this upper limit. At lower A_{w} values, a hot fill and hold process is acceptable for providing sufficiently long shelf life. The addition of the carbohydrate RI-adjusting component assists in lowering the A_{w} value for the total composition.

Further ingredients of the composition may include an emulsifier system, a buffer system, a foam stabilizer and a flavorant. The flavorant may, for example, comprise a coffee aroma constituent. However, any other suitable desired aroma of flavoring component may be utilized.

The emulsifier system, where used, includes a first emulsifier agent that serves to prevent coalescence of the dispersed globules of the dispersed phase, keeping them in suspension. The first emulsifier agent is desirably present in concentration from up to about 2.5%, preferably from about 1% to 2% by weight of the total composition. Sodium caseinate is a preferred example of such agent. Other non-limiting examples that may be employed include soy protein isolate, wheat protein isolate, non-fat dry milk solids and modified starch and combinations thereof.

To further improve the stability of the emulsion, an additional emulsifying agent may be included in the composition. Non-limiting examples of such additional agent are distilled monoglyceride or mono-diglyceride, sodium stearoyl lactylate, diacetyl tartaric acid ester of monoglycerides (DATEM) and combinations thereof. Suitable examples of mono- and mono-diglycerides are those sold under the trade name Dimodan BPTK or Panodan 160, available from Danisco Ingredients USA, Inc of New Century, Kans., USA.

In preferred embodiments, the second emulsifying agent is soluble in the lipid phase and comprises from about 0.2% to 1.5% of the total composition, but more preferably from 0.5% to 1% by weight.

The composition may further comprise a system buffer. This is useful to buffer the pH of the liquid composition upward, so as to stabilize the protein. Preferably, the pH range is from about 6 to 8 and more preferably from about 6.5 to 7.5. Having the pH in these ranges is found to improve the emulsion stability of the liquid creamer once it is in the beverage. Non-limiting examples of suitable buffers are salts such as potassium phosphate, sodium bicarbonate, sodium citrate and sodium tripolyphosphate. These are preferably present from about 0.5% to about 1% of the total weight of the composition.

The composition may further include a foam stabilizer, especially where a degree of foaminess is desired in the creamed beverage. The foam stabilizer may comprise a suitable gum such as carageenan. Alternatives or additional options for inclusion are, by way of example, guar gum, CMC, locust bean gum, MCC, sodium alginate and the like. The stabilizer may comprise from 0% to about 0.3% of the total weight of the composition.

Manufacture of the creamer composition may be performed by gathering together the required ingredients, charging them into a mixing vessel containing a measured quantity of solvent and forming a wet mix with them at moderate temperature, for example in the range from about 70 to 80° C., preferably from about 73 to 75° C. The mix may be homogenized thereafter, preferably in a two stage process to form a clear liquid concentrate which may then be filled into containers as required. Preferably, the temperature of filling is maintained for a hold time of up to about six minutes. Typically, a period of about 2 to 3 minutes is sufficient at a temperature in the range from about 80° C. to 85° C. Filling may be in any suitable container, from relatively inflexible bottles, jars and the like to flexible tubes, sachets, pouches, bags and the like.

The creamer of this invention is found to be suitable for use not only with traditional warm beverages such as hot coffee, tea and chocolate and malt drinks, but also with cold drinks such as iced coffee, iced tea and milkshakes. It may also be added to granitas and fruitshakes and ice cream dessert drinks such as floats. It may also be applied in desserts and creamy dessert toppings and the like.

The beverage creamer may be packaged to provide a product comprising a container having a transparent wall portion defining an internal space within which is contained a visually clear creamer composition. The package may, in an embodiment, comprise a sterilized transparent glass or plastics jar or tube with a suitable sealing lid for multiple servings. Alternatively it could be equipped with a dispensing device associated with the top of the jar or tube—for example a dosage system or nozzle arrangement. Single serve packaging may include a sealed, transparently-walled capsule or canister having a removable sealing membrane, such as a peelable lid.

When subjected to a shelf stability test, it was found that after opening of the container, the creamer composition exhibited a shelf life of at least one month at ordinary room temperatures in the range from 20° C. to 25° C. The low A_{w} of the product—desirably controlled to be below 0.85—inhibits the growth of microorganisms and enables the product to remain shelf stable at most ambient conditions, even after opening. The unopened shelf life of the product is found even to exceed one year.

It will be appreciated by the person skilled in the art that numerous modifications may be made to the relative proportions and selections of the various components, without departing from the spirit and scope of the invention. For example, variations may be made with regard to:

The choice of emulsifier, such as sodium caseinate, wheat protein isolate, soy isolate, modified starch and the like

The type of lipid and degree of hydrogenation—for example the selection of palm kernel, coconut, canola, soy, corn, palm, or sunflower oil and the like. Since each of these has a slightly differing refractive index, the eventual formulation would depend on the RI of the oil selected.

The lipid/water/RI-adjusting solute ratio: In the case where the RI of the aqueous phase or phases needs to be adjusted to match that of the lipid phase, as the lipid content is increased, the water and solute content necessarily decreases. This is because at higher lipid levels, there is less water present. Consequently less solute needs to be added to raise the RI to match that of the lipid.

### EXAMPLES

The following are non-limiting examples of suitable formulations of the creamer of the present invention.

### Example 1

A creamer liquid composition is prepared from the ingredients below in the following manner.

A quantity of water to make up 30% by weight of the final composition is put into a Lanco mixing vessel. Dipotassium phosphate is added, followed by sodium caseinate, flavorant, oil and emulsifier. The temperature is raised to and maintained at about 75° C. Sucrose is added slowly while the ingredients are continuously mixed. This provides a wet mix. The mix is then homogenized in two stages, at 2500 psi and 500 psi respectively, before being filled as a clear liquid into a container. The temperature of filling is maintained at about 82° C. for two minutes hold time. The composition of the liquid composition is (weight %):

| | |
|---|---|
| Water | 30% |
| Sucrose | 55% |
| Palm kernel oil | 13% |
| Sodium caseinate | 1% |
| Emulsifier (Panodan 160K) | 0.3% |
| Dairy flavor | 0.2% |
| Dipotassium phosphate | 0.5% |

The composition is tested for shelf stability. A 100 ml volume is retained in an uncovered container at 23° C. for 30 days. At the end of this period, it exhibits no rancidity or other noticeable off notes and has a clear appearance.

A second such quantity is retained in a sealed, transparent container for 1 year after which it is opened. It too exhibits no discernable off notes.

### Example 2

A liquid creamer was formulated from the following ingredients, which were mixed together and homogenized and filled as in example 1 (units are weight %):

| | |
|---|---|
| Water | 28% |
| Sucrose | 51.9 |
| Palm kernel oil | 18% |
| Sodium caseinate | 1% |
| Sodium Stearoyl Lactylate | 0.2% |
| Dairy flavor | 0.2% |
| Dipotassium phosphate | 0.5% |
| Polysorbate 60 | 0.2% |

Again, a clear liquid emulsion resulted and was filled into glass containers and sealed. The creamer stored in this way passed a one-year shelf stability test in the sealed container and one month in an open container. When added to a coffee beverage, it exhibited strong whitening performance and gave the beverage a creamy mouthfeel. No coalescence of oil droplets was apparent.

### Example 3

A third creamer liquid composition is prepared from the ingredients below in the following manner.

The measured quantity of water is run into a mixing vessel. Dipotassium phosphate is added, followed by sodium caseinate, flavorant, oil and emulsifier. Temperature is raised to be maintained at about 72° C. Sucrose is added slowly while the ingredients are mixed continuously to form a wet mix. The mix is then homogenized in two stages, at 2200 psi and 500 psi respectively, before being filled as a clear liquid into sachet containers. The temperature of filling is maintained at about 80° C. for about three minutes hold time. The composition of the liquid composition in weight % is:

| | |
|---|---|
| Water | 25% |
| Sucrose | 58% |
| Canola oil | 15% |
| Sodium caseinate | 1% |
| Emulsifier (Panodan 160K) | 0.3% |
| Dipotassium phosphate | 0.5% |

The composition provides a clear liquid that turns creamy and opaque when diluted by being added to water. In this form it is served as a rich and creamy dessert topping. In tea and coffee it exhibits the same performance.

It will be appreciated that various modifications and variations of the exemplary embodiments disclosed above may be made without departing from the scope of the invention as defined above and with reference to the appended claims.

What is claimed is:

1. A creamer composition comprising at least two phases having equal or substantially equal refractive indices so as to render the composition substantially transparent, and an emulsifier system comprising a first emulsifying agent.

2. The creamer composition according to claim 1, wherein the first emulsifying agent is selected from the group consisting of sodium caseinate, soy protein isolate, wheat protein isolate, non-fat milk solids, modified starch and combinations thereof.

3. The creamer composition according to claim 1, that is colorless.

4. The creamer composition according to claim 1, that is colored but transparent.

5. The creamer composition according to claim 1, wherein at least one of the phases is an aqueous phase.

6. The creamer composition according to claim 5, wherein at least one other phase is a lipid phase.

7. The creamer composition according to claim 4, wherein the aqueous phase is continuous and the lipid phase is dispersed in the aqueous phase.

8. The creamer composition according to claim 1, in liquid form.

9. The creamer composition according to claim 1, wherein the refractive index of each phase is in the range from about 1.43 to about 1.48.

10. The creamer composition according to claim 5, wherein the aqueous phase comprises a solute.

11. The creamer composition according to claim 10, wherein the aqueous phase comprises from about 40% to 85% by weight solute.

12. The creamer composition according to claim 10, wherein the solute is an edible carbohydrate.

13. The creamer composition according to claim 10, wherein the solute is a low molecular weight carbohydrate.

14. The creamer composition according to claim 10, wherein the solute is a non-reducing sugar.

15. The creamer composition according to claim 14, wherein the non-reducing sugar is non-browning.

16. The creamer composition according to claim 14, wherein the sugar comprises sucrose.

17. The creamer composition according to claim 14, wherein the aqueous phase comprises from about 40% to about 85% by weight of sugar.

18. The creamer composition according to claim 1 having water activity of about 0.9 or less.

19. The creamer composition according to claim 1, wherein at least one of the phases is a lipid phase.

20. The creamer composition according to claim 19, wherein the lipid phase comprises an edible oil.

21. The creamer composition according to claim 20, wherein the oil is lightly or partially hydrogenated.

22. The creamer composition according to claim 21, wherein the oil has a melting point of about 35° C. or less.

23. The creamer composition according to claim 19, wherein the lipid phase comprises about 25% or less of the total weight of the creamer composition.

24. A method of manufacturing a creamer composition which comprises providing a first component selected to have creamy mouthfeel characteristics, when diluted in a beverage, to form a first phase, providing a second component to form a second phase when mixed with the first component, providing an emulsifier system comprising a first emulsifying agent, mixing the first and second components and the emulsifier system together, and, if necessary, adjusting the refractive index of at least one phase to equal or substantially equal the value of each other phase to provide a clear composition.

25. The method according to claim 24, wherein the step of mixing includes forming an emulsion of the phases.

26. The method according to claim 24, wherein at least one of the components is a liquid.

27. The method according to claim 24, wherein the first phase comprises an edible lipid constituent to provide a lipid phase.

28. The method according to claim 24, wherein the second phase comprises an aqueous solvent to provide an aqueous phase.

29. The method according to claim 25, wherein the emulsion comprises a lipid phase dispersed in an aqueous phase.

30. The method according to claim 24, which further comprises dissolving in sufficient quantity in one of the phases a solute for adjusting the refractive index of that phase to a value that equals or approximately equals the refractive index of the other phase, to provide a clear composition.

31. The method according to claim 30, wherein the solute is dissolved in the aqueous phase.

32. The method according to claim 30, wherein the solute is a non-reducing sugar.

33. The method according to claim 32, wherein the aqueous phase comprises from about 40% to about 85% by weight of the sugar.

34. A method of creaming a beverage which comprises rendering an uncreamed beverage to be creamy by providing a transparent beverage creamer composition according to claim 1 and mixing a sufficient amount of the creamer composition with the beverage until the beverage takes on a desired creamy appearance.

35. The method according to claim 34, wherein the creamer composition is in liquid form.

36. The method according to claim 34, wherein the creamer composition is provided in concentrate form.

37. The method according to claim 34, wherein the beverage is aqueous.

38. The method according to claim 34, wherein at least one of the phases comprises a solute in sufficient quantity for adjusting the refractive index of that phase to a value that equals or approximately equals the refractive index of each other phase to provide a clear composition.
